(19) United States
(12) Patent Application Publication
(10) Pub. No.: US 2021/0192614 A1
(43) Pub. Date: Jun. 24, 2021

(54) SYSTEMS AND METHODS FOR DETERMINING AN AFFORDABILITY INDEX

(71) Applicant: Cash Flow Solutions, Inc., Oxford, OH (US)

(72) Inventors: Steven Thompson, Escondido, CA (US); Eric VonDohlen, Escondido, CA (US); Carl Spiker, Escondido, CA (US)

(21) Appl. No.: 17/125,924

(22) Filed: Dec. 17, 2020

Related U.S. Application Data
(60) Provisional application No. 62/950,086, filed on Dec. 18, 2019.
(60) Provisional application No. 62/987,729, filed on Mar. 10, 2020.

(51) Int. Cl. G06Q 40/02; G06F 16/901

(52) U.S. Cl. CPC G06Q 40/025; G06F 16/9024

(57) ABSTRACT

Embodiments of the present disclosure relate generally to systems and methods for determining an affordability index. In an embodiment, a system comprises at least one processor; and memory storing instructions that, when executed by the at least one processor, causes the system to perform a set of operations. the set of operations comprises receiving a plurality of financial transactions for an entity during a period of time, wherein each of the plurality of financial transactions comprises one or more descriptions. In addition, the set of operations comprises cleaning the descriptions from the plurality of financial transactions to create one or more corresponding clean descriptions. Further, the set of operations comprises populating a plurality of fields with field entries using the clean descriptions. And, the set of operations comprises producing a graph network comprising a plurality of nodes and links, wherein the nodes correspond to the field entries and the links connect one or more of the field entries based on a similarity of the field entries.

### CROSS REFERENCE TO RELATED APPLICATIONS

This application claims the benefit of U.S. Provisional Application Ser. No. 62/950,086, filed Dec. 18, 2019 and U.S. Provisional Application Ser. No. 62/987,729, filed Mar. 10, 2020 The disclosure of these prior applications are considered part of and are incorporated by reference in the disclosure of this application, for all purposes.

### TECHNICAL FIELD

The present disclosure relates generally to systems and methods used to assess credit risk and performance pertaining to financial assets, such as loans, securities, payment transactions, and so forth. More particularly, the present disclosure relates to a method and system for determining the probability of an event in connection with a credit product (e.g., delinquency, fraud, default, prepayment, etc.). Further, the present disclosure relates to a method and system for assessing the financial behavior and performance of a consumer or business based on their bank account transactions over a period of time. Further, the present disclosure relates to generating an affordability recommendation based upon a set of financial transactions.

### BACKGROUND

The ability to assess risk and affordability is important in the context of financial lending. A defaulted loan or a delinquent loan is costly to the owner of the asset (initially the lender). As a lender improves its ability to determine risk associated with a loan, it can make better underwriting and pricing decisions that will result in fewer loans that default or become delinquent. Better risk predictions, therefore, decrease the defaults/delinquencies, improve capital flow in the market(s) for which the loan was made, and ultimately decrease lending costs for consumers. Further, consumers and businesses benefit since the lender will be able to improve the lending limits, pricing of the loan or services and pass along cost savings.

### SUMMARY

Examples disclosed herein may reduce some of the shortcomings associated with conventional models that quantify the behavior of a consumer or a business. Examples embodiments include, but are not limited to the following examples.

In an Example 1, a system for determining an affordability index, the system comprising: at least one processor; and memory storing instructions that, when executed by the at least one processor, causes the system to perform a set of operations, the set of operations comprising: receiving a plurality of financial transactions for an entity during a period of time, wherein each of the plurality of financial transactions comprises one or more descriptions; cleaning the descriptions from the plurality of financial transactions to create one or more corresponding clean descriptions; populating a plurality of fields with field entries using the clean descriptions; and producing a graph network comprising a plurality of nodes and links, wherein the nodes correspond to the field entries and the links connect one or more of the field entries based on a similarity of the field entries.

In an Example 2, the system of Example 1, the set of operations further comprising determining a similarity between field entries.

In an Example 3, the system of any of Examples 1-2, wherein the links comprise weights corresponding to a similarity between the field entries.

In an Example 4, the system of any of Examples 1-3, the set of operations further comprising: creating a first set of metrics for similarities over a first of the predetermined interval of time; creating a second set of metrics for similarities over a second of the predetermined interval of time, wherein the second of the predetermined interval of time is a same duration as the first of the predetermined interval of time but a different in range than first of the predetermined interval of time; comparing the first set of metrics to the second set of metrics; and outputting the comparison and/or summary of comparison of the first set and second set of metrics.

In an Example 5, the system of Example 4, wherein the predetermined interval of time comprises at least one of hours, days, weeks, months and years.

In an Example 6, the system of any of Examples 4-5, the set of operations further comprising: determining a trend for the first set of metrics; and determining a velocity of the trend.

In an Example 7, the system of Example 6, the set of operations further comprising determining a change of the velocity of the trend.

In an Example 8, the system of any of Examples 1-7, the set of operations further comprising: identifying repetitive financial transactions from the plurality of financial transactions during a predetermined interval of time; identifying one or more obligatory financial transactions from the repetitive financial transactions; identifying whether the one or more obligatory financial transactions are being satisfied; and generating an affordability index for a type of transaction similar to the one or more obligatory financial transactions based upon whether the obligatory financial transactions are being satisfied.

In an Example 9, the system of Example 8, wherein the predetermined interval of time comprises at least one of hours, days, weeks, months and years.

In an Example 10, the system of any of Examples 8-9, the set of operations further comprising determining a trend associated with the satisfaction of the obligatory financial transactions.

In an Example 11, the system of any of Examples 8-10, the set of operations further comprising determining a risk index based on the affordability index.

In an Example 12, the system of any of Examples 8-11, the set of operations further comprising generating an affordability recommendation for the type of transaction based on the affordability index.

In an Example 13, the system of Example 12, wherein the affordability recommendation corresponds to whether the entity can afford a credit product associated with the type of transaction

In an Example 14, the system of Example 13, wherein, in response to determining the entity can afford a credit product, the set of operations further comprises providing recommended terms, a payment amount, and a day of the week for the payment amount to be paid.

In an Example 15, the system of any of Examples 1-14, the set of operations further comprising: receiving a first set of personal identification information associated with a lending application; receiving a second set of personal identification information associated with a bank account; comparing the first set of personal identification information associated with the lending application with the plurality of financial transactions; comparing the second set of personal identification information associated with the bank account with the plurality of financial transactions; and generating a risk index based upon the comparisons, wherein the risk index corresponds to whether the first set of personal identification and the second set of personal identification information are associated with the entity.

In an Example 16, a method for determining an affordability index, the method comprising: receiving a plurality of financial transactions for an entity during a period of time, wherein each of the plurality of financial transactions comprises one or more descriptions; cleaning the descriptions from the plurality of financial transactions to create one or more corresponding clean descriptions; populating a plurality of fields with field entries using the clean descriptions; and producing a graph network comprising a plurality of nodes and links, wherein the nodes correspond to the field entries and the links connect one or more of the field entries based on a similarity of the field entries.

In an Example 17, the method of Example 16, further determining a similarity between field entries.

In an Example 18, the method of any of Examples 16-17, wherein the links comprise weights corresponding to a similarity between

In an Example 19, the method of any of Examples 16-18, further comprising: creating a first set of metrics for similarities over a first of the predetermined interval of time; creating a second set of metrics for similarities over a second of the predetermined interval of time, wherein the second of the predetermined interval of time is a same duration as the first of the predetermined interval of time but a different in range than first of the predetermined interval of time; comparing the first set of metrics to the second set of metrics; and outputting the comparison and/or summary of comparison of the first set and second set of metrics.

In an Example 20, the method of Example 19, wherein the predetermined interval of time comprises at least one of hours, days, weeks, months and years.

In an Example 21, the method of any of Examples 19-20, further comprising: determining a trend for the first set of metrics; and determining a velocity of the trend.

In an Example 22, the method of Example 21, further comprising: determining a change of the velocity of the trend.

In an Example 23, the method of any of Examples 16-22, further comprising: identifying repetitive financial transactions from the plurality of financial transactions during a predetermined interval of time; identifying one or more obligatory financial transactions from the repetitive financial transactions; identifying whether the one or more obligatory financial transactions are being satisfied; and generating an affordability index for a type of transaction similar to the one or more obligatory financial transactions based upon whether the obligatory financial transactions are being satisfied.

In an Example 24, the method of Example 23, wherein the predetermined interval of time comprises at least one of hours, days, weeks, months and years.

In an Example 25, the method of any of Examples 23-24, further comprising determining a trend associated with the satisfaction of the obligatory financial transactions.

In an Example 26, the method of any of Examples 23-25, further comprising determining a risk index based on the affordability index.

In an Example 27, the method of any of Examples 23-26, further comprising generating an affordability recommendation for the type of transaction based on the affordability index.

In an Example 28, the method of Example 27, wherein the affordability recommendation corresponds to whether the entity can afford a credit product associated with the type of transaction

In an Example 29, the method of Example 28, wherein, in response to determining the entity can afford a credit product, the method comprises providing recommended terms, a payment amount, and a day of the week for the payment amount to be paid.

In an Example 30, the method of any of Examples 16-29, further comprising: receiving a first set of personal identification information associated with a lending application; receiving a second set of personal identification information associated with a bank account; comparing the first set of personal identification information associated with the lending application with the plurality of financial transactions; comparing the second set of personal identification information associated with the bank account with the plurality of financial transactions; and generating a risk index based upon the comparisons, wherein the risk index corresponds to whether the first set of personal identification and the second set of personal identification information are associated with the entity.

While multiple examples are disclosed, still other embodiments of the present disclosure will become apparent to those skilled in the art from the following detailed description, which shows and describes illustrative examples of the disclosure. Accordingly, the drawings and detailed description are to be regarded as illustrative in nature and not restrictive.

### BRIEF DESCRIPTION OF THE DRAWINGS

FIG. 1 is an illustration of a flow diagram for a method of identifying and/or determining relationships between a set of bank account transactions over a period of time, in accordance with an embodiment of the present disclosure. These fields are used to instantiate a graph network to create (via automatic or artificially intelligent methods) clusters of behavior to better understand how spending and inflows correlate with each other in the form of network attributes such as density, size of network, centrality, authority, etc.

FIG. 2 is an illustration of simplified graph network linking nodes associated with transactions, in accordance with an embodiment of the present disclosure.

FIG. 3 is an illustration of a flow diagram for a method of quantifying spending behavior from a set of bank account transactions over a period of time, in accordance with an embodiment of the present disclosure.

FIG. 4 is an illustration of a flow diagram for a method of determining affordability from a set of bank account transactions over a period of time, in accordance with an embodiment of the present disclosure.

FIG. 5 is an illustration of a flow diagram for a method of identifying fraud risk from a set of bank account transactions over a period of time, in accordance with an embodiment of the present disclosure.

FIG. 6 is an illustration of a block diagram of an example computer system which may be used to implement all or certain or a combination of the methods illustrated in FIGS. 1, 3-5 and/or implement all or certain or a combination of aspects of the examples discussed herein.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

In the following detailed description, reference is made to the accompanying drawings which form a part hereof, and in which is shown by way of illustration specific embodiments in which the present disclosure is practiced. These embodiments are described in sufficient detail to enable those skilled in the art to practice the present disclosure, and it is to be understood that other embodiments can be utilized and that structural changes can be made without departing from the scope of the present disclosure. Therefore, the following detailed description is not to be taken in a limiting sense, and the scope of the present disclosure is defined by the appended claims and their equivalents.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments. Furthermore, the described features, structures, or characteristics of the subject matter described herein may be combined in any suitable manner in one or more embodiments.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

Although the term “block” may be used herein to connote different elements illustratively employed, the term should not be interpreted as implying any requirement of, or particular order among or between, various steps disclosed herein unless and except when explicitly referring to the order of individual steps. Additionally, a “set” or “group” of items (e.g., inputs, algorithms, data values, etc.) may include one or more items, and, similarly, a subset or subgroup of items may include one or more items.

As set forth above, embodiments disclosed herein, which are rooted in computer technology (e.g., machine learning) may reduce some of the shortcomings associated with conventional models that quantify the behavior of a consumer or a business.

Traditionally, lending institutions, such as banks, have assessed loan risk using credit reports and/or credit scores. Credit reports are records sent from a credit reporting agency to prospective lenders, employers, and insurers that provide information about the credit standing of a consumer. Credit reporting agencies are companies that gather the information about consumers and sell it to creditors and/or employers and/or insurers. A credit score often refers to a number generated by a statistical model that is used to evaluate the credit worthiness of a borrower(s) for making a credit decision. The credit score, however, is typically based on an entity's (e.g., consumer, user, or business) credit standing at a particular point in time, for example, the date on which the entity applies for a loan. That is, the credit score is a static snapshot of the entity's then current financial information, thereby providing the lending institution with limited information regarding the entity's overall financial behavior and trends in the entity's financial behavior.

Further, an entity's credit score is exclusively based on information that has been reported by various lenders to a credit reporting agency. Oftentimes, however, reporting by lenders to credit reporting agencies can be delayed by weeks or even months. As such, if an entity has recently been behind on payments to a lender, the entity's credit score may not reflect those late payments in the event the lender has not reported it to a credit reporting agency. Similarly, if an entity recently paid off a loan balance, the paid off loan balance may not be reflected in the entity's credit score in the event the lender has not reported it to a credit reporting agency.

The embodiments disclosed herein provide solutions to these shortcomings associated with a credit score. Specifically, instead of evaluating an entity's creditworthiness at a particular point in time using credit score, the embodiments disclosed herein evaluate an entity's ability to afford a particular credit product based upon a window of time using a history of transactional behavior. This allows a lender to determine whether an entity's ability to afford a particular credit product is increasing or decreasing. Furthermore, instead of relying on potentially delayed information like a credit score may do, the embodiments disclosed herein analyze an entity's bank transactions so that up-to-date information can be used to determine an entity's spending behavior, which can be used by a lender to determine whether an entity can afford a particular credit product. In order to determine an entity's spending behavior based upon bank transactions, the embodiments disclosed herein link similar transactions using a graph network. Linking similar transactions using a graph network is an improvement over conventional embodiments that attempt to categorize spending into different categories utilizing a stored list of matching transactions. In particular, categorizing transactions has led to a focus on disposable income alone as a use case for bank behavior rather than focusing on an expansive view of affordability which is accomplished by linking similar transactions using a graph network.

Another shortcoming to existing methodologies includes the assumption that all transactions in a category have the same level of risk. For example, if a consumer spends $100 at Walmart, existing methodologies may categorize that spending as retail spending and spending in that category may be assigned a certain level of risk regardless of what is being purchased. However, purchasing $100 of groceries at Walmart versus purchasing $100 of lottery tickets at Walmart indicate two different risk profiles for a consumer. As such, spending $100 at Walmart that is categorized as “retail spending” does not differentiate between consumer spending habits and the ability and willingness of that consumer to repay a credit product. Instead, it is the presence of that spending amongst other related transactions linked within a graph network and associated with velocity of the balance and inflows and outflows that determines a consumer's ability to repay and afford a credit product.

The distortion of risk is further exacerbated by the limitations to the size of the list of transactional matching that determines categories. That is, the larger the corpus of the category, the greater the likelihood distortion exists. And the categorized groupings, relationships, and quantification between those transactions is often static until updated by a manual process, thereby being entirely dependent on the validity of categorization matching and timeliness of corpus updates.

The problems discussed above with respect to assigning the same level of risk to each category, is even further magnified when such categorization is not adjusted for particular languages or for specific regions or countries, thereby further increasing the likelihood that the identified risk is either incorrect or distorted. Embodiments disclosed herein provide solutions to these problems.

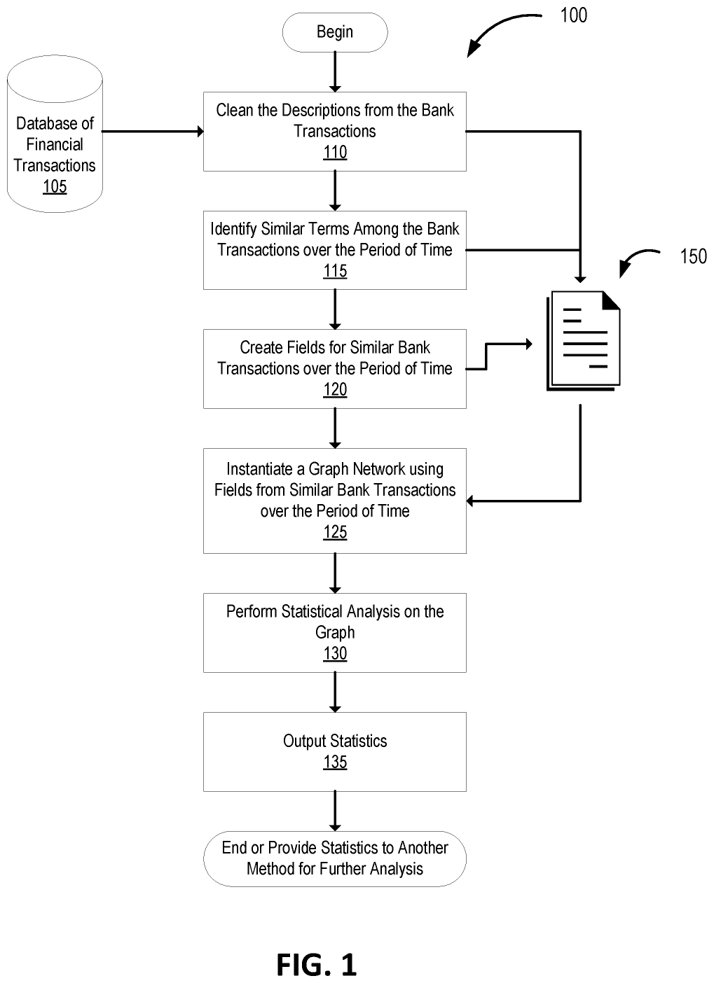

FIG. 1 illustrates a flow diagram for a method 100 of identifying and/or determining relationships between a set of bank account transactions over a period of time. The method 100 may preferably be performed by a computer program comprising instructions that cause one or more processors to perform the steps of the method, wherein the computer program is stored on non-transitory computer readable medium. This diagram is merely an example, which should not unduly limit the scope of the claims. One of ordinary skill in the art would recognize many variations, alternatives, and modifications.

The method 100 may begin by receiving or accessing from a database 105, a set of financial transactions performed over a period of time. While FIG. 1 illustrates a single database 105, the database 105 may be a plurality of databases 105 managed by the same institution or a variety of institutions.

The financial transactions may include, but are not limited to, bank transactions, credit union transactions, checking account transactions, savings account transactions, credit card transactions, etc. Each financial transaction will typically have a description that describes the transaction. Each transaction will also have additional data associated therewith. The additional data associated with each transaction may include, but is not limited to, the payee, the transaction amount, the date of the transaction, the day of the week of the transaction, the type of transaction, whether the transaction was for goods or services, etc.

Upon receiving the set of financial transactions, the method 100 may clean the descriptions associated with the financial transactions (step 110). The cleaned description for each financial transaction may be produced by using a unique and/or proprietary natural language processing algorithm. Specifically, the natural language programming algorithm may create a regular expression or a plurality of regular expressions for each raw description of a financial transaction. A regular expression, or “regex” for short, is a pattern of text. In other words, a regex is a sequence of characters that define a search by matching the literal text to the regex. Typically, patterns are used by string searching algorithms, and a pattern “match” is the piece of text, or sequence of bytes or characters that pattern was found to correspond to by the regex processing software. After the regex is applied, the string is cleaned and superfluous prefixes are removed while keeping the descriptive information for the string, thereby producing one or more clean descriptions for each raw description.

The regex may built by sub-setting the description field. For example, the regex may be built by sub-setting the description field according to the following: 1.) making text lower case, 2.) splitting the description into numeric vs alpha characters, 3.) parsing the description into n-grams, and/or 4.) reviewing associations/string matching to other portions of descriptions and applicant information to find matches. In at least some examples, a prefix is superfluous if it occurs multiple times in the n-gram toward the beginning of the description and it does not occur across a plurality of transactions.

After creating the clean description(s), the natural language programming algorithm identifies the parts of the clean descriptions that are similar amongst the transactions. Each similar portion of the transactions may be identified in a field. By identifying the similarities amongst the transactions rather than trying to identify certain words, the natural language programming algorithm is language and transaction provider agnostic.

Step 110 may include creating a new document 150 that includes the initial raw description for each transaction and a cleaned description corresponding to the initial raw description, below the raw description, as shown below in Table 1.

TABLE 1

| | | | | Field 3 | | | Field 6 | |
|---|---|---|---|---|---|---|---|---|
| | | | | Day of | | | Goods or | |
| Item | | Field 1 | Field 2 | Week | Field 4 | Field 5 | Services | Field n |
| No. | Description | Payee | Date | (DoW) | Amount | Type | (G or S) | Etc. |
| 1 | Raw Description A | | | | | | | |
| | Clean | Payee A | Date A | DoW A | Amount A | Type A | G or S A | Etc. A |
| | Description A | | | | | | | |
| 2 | Raw Description B | | | | | | | |
| | Clean | Payee B | Date B | DoW B | Amount B | Type B | G or S B | Etc. B |
| | Description B | | | | | | | |

. . .

| N | Raw Description N | | | | | | | |
|---|---|---|---|---|---|---|---|---|
| | Clean | Payee N | Date N | DoW N | Amount N | Type N | G or S N | Etc. N |
| | Description N | | | | | | | |

As shown in Table 1, each financial transaction includes a raw description, but at the time the algorithm receives the financial transactions, the fields are not identified or linked. In certain instances, the algorithm cleans the raw description, thereby creating one or more clean descriptions, and correlates an item number for each clean description. In some embodiments, after creating one or more clean descriptions for each raw description, the algorithm identifies similar terms among the transactions (step 115). In some aspects, the fields may be created. In some embodiments, the similar terms may be used to create fields for the transactions (step 120). For example, the terms may be identified as pertaining to a particular category for the transaction and a field may be generated based on the particular category. In some embodiments, the fields are pre-determined and the terms are assigned to a field based on a correspondence between the term and the field. In the illustrated embodiment, the fields may include the payee for the transaction, the date of the transaction, the day of the week (DoW) of the transaction, the amount of the transaction, the type of transaction (e.g., withdrawal, deposit, credit, fee, etc.), the goods and/or services purchased in the transaction, etc. Once the fields are created, the fields may be populated with field entries, i.e., clean descriptions and/or other information from the transaction(s). Each entry into a field may be referred to herein as a field entry. Step 120 may also create and identify additional or derivative field from the initially identified fields. For example, Table 1 depicts Field 2 as the date of the transaction, which may be an initially identified field. Table 1 depicts Field 3 as the DoW. The DoW field may be an initially identified field or a derivative field because the DoW is derived from the date of the transaction in Field 3. A derivative field may, therefore, be considered a field that is derived from an initially derived field or a separate derived field.

After identifying the fields, the method 100 may include the step of instantiating a graph network using fields from similar transactions (step 125). Such step may include creating a data set from a series of nodes. For example, node 1 may include the item number for a first transaction. Node 2 may include the clean description for the first transaction. These nodes can be linked due to being included in the same transaction. Node 3 may include a DoW for a transaction. Node 3 may be linked to Node 2 if the first transaction corresponding to the clean description of Node 2 occurred on the DoW specified in Node 3. Node 4 may include a transaction amount and may be linked to Node 2 if the first transaction corresponding to the clean description of Node 2 had the same or similar transaction amount specified in Node 4. Node 5 may include a transaction type and may be linked to Node 2 if the first transaction corresponding to the clean description of Node 2 had the same or similar transaction type specified in Node 5. This process may continue until a graph network is established that includes most or all the transactions of Table 1.

In some embodiments, the “weight” of the links (or edges) between the nodes may correspond to how closely (e.g., similarity) the two nodes are connected by similarity of the description, transaction amount, numeric values, metadata associated with the transaction, and/or other information associated with the node. For example, if the nodes for two clean descriptions for two different transaction are very closely related due to, for example, the description, transaction amount, numeric values, metadata associated with the transaction, and/or other information associated with the node, then the weight of the link connecting the two nodes may be high. Conversely, if the nodes for two clean descriptions for two different transaction are only somewhat related then the weight of the two nodes may be minimized.

In some embodiments, step 125 may include parsing the graph so that nodes having links or links above a threshold weight are included in the same grouping. And, the transactions included in each grouping are then labeled as related. Once related transactions are linked the graph is then used to identify linked spending events, linked events that cause adverse events (e.g., overdrafts), and how the links and strengths of linkages changes over time.

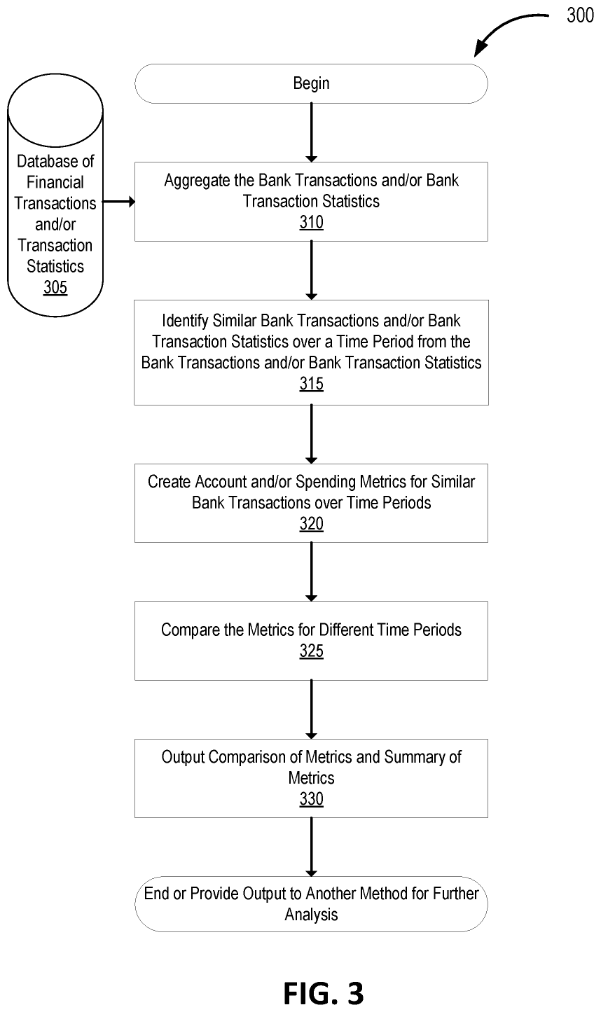

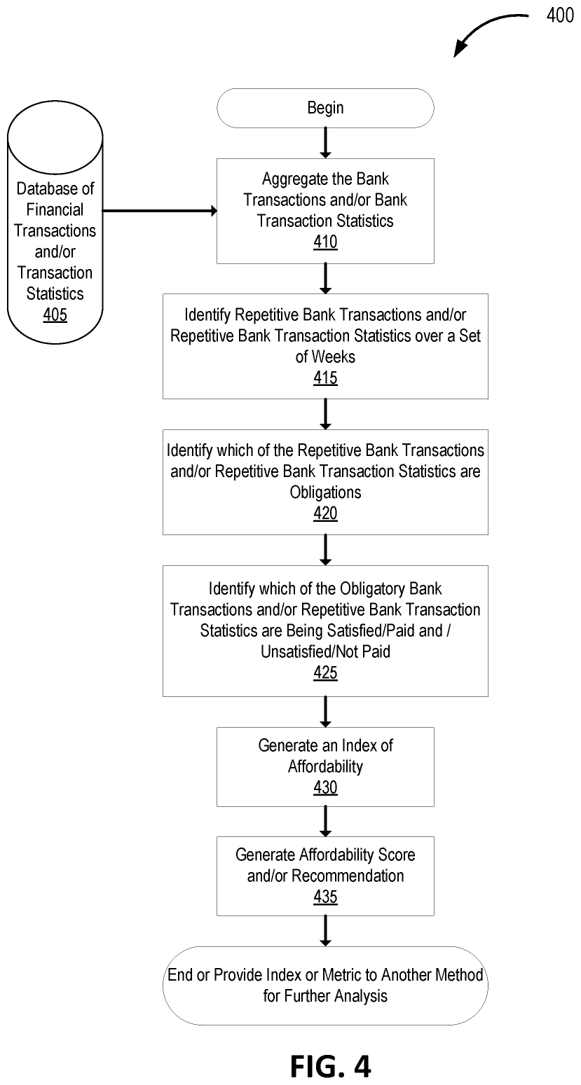

The method 100 may also include step 130 which performs statistical analysis on the graph and calculates and/or determines transaction statistics for each set of nodes and/or links within the graph. In some embodiments, the transaction statistics may include density of nodes and/or links, size of nodes and/or links with the graph, and centrality of nodes and/or links with the graph. Once the statistics are generated in method 100, those statistics may be used by other methods described in this disclosure, such as the method for quantifying spending behavior from financial transactions depicted in FIG. 3 and/or the method for determining affordability from financial transactions depicted in FIG. 4. As explained in more detail below, the transaction statistics can be used to (1) generate insights related to temporal behavior in the presence of various credit products, (2) estimate the impact to affordability from the velocity of inflows and outflows, and (3) identify connections between transactions that have an impact to risk of default.

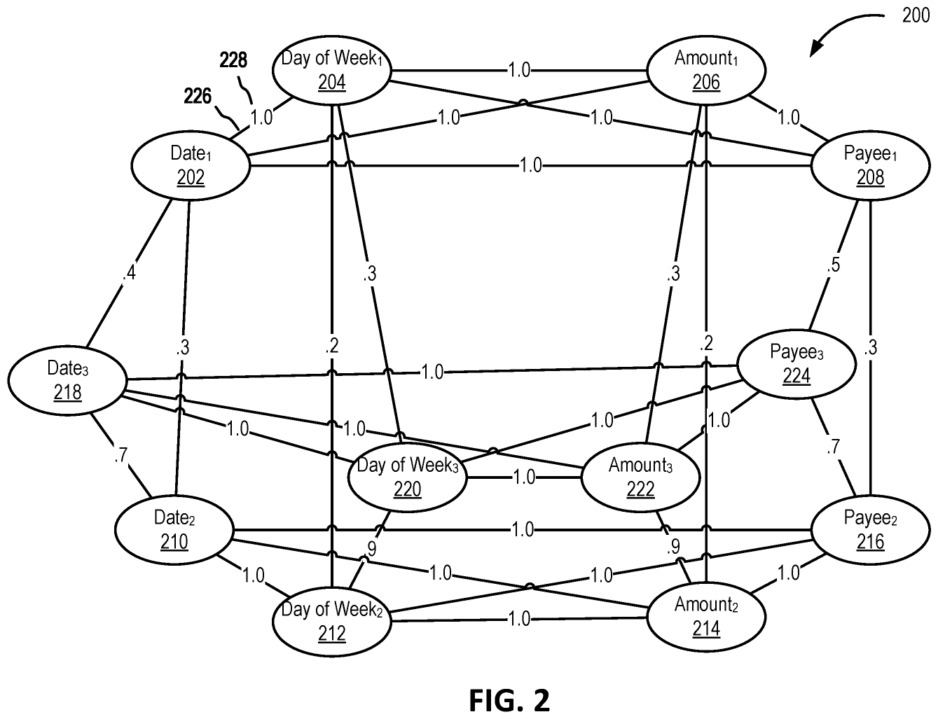

FIG. 2 is an illustration of simplified graph network 200 linking nodes 202-224 associated with transactions, in accordance with embodiments of the present disclosure. This diagram is merely an example, which should not unduly limit the scope of the claims. One of ordinary skill in the art would recognize many variations, alternatives, and modifications.

As illustrated, the graph network 200 illustrates nodes 202-224 associated with three different transactions. In aspects, the specific transaction for which a node 202-224 is associated with is denoted by a subscript number. For example, Date₁ 202, Day of Week₁ 204, Amount₁ 206, Payee₁ 208 are all associated with a first transaction, Date₂ 210, Day of Week₂ 212, Amount₂ 214, Payee₂ 216 are all associated with a second transaction, and Date₃ 218, Day of Week₃ 220, Amount₃ 222, Payee₃ 224 are all associated with a third transaction. While the illustrated graph network 200 only depicts three transactions and four respective nodes 202-224 for each transaction, a typical graph network may include hundreds or thousands of transactions and tens or hundreds of nodes 202-224 for each transaction.

As illustrated, the graph network 200 includes links (e.g., link 226) connecting various nodes 202-224. For each link 226, a weight 228 may be assigned to the link based on the similarity of the nodes 202-224 that the link 226 connects. That is, a higher weight assigned to a link 226 denotes the nodes for which the link 226 connects are more similar than if the link 226 were assigned a lower weight. For example, Date₁ 202 is more closely related to Date₃ 218 than it is to Date₂ 210.

In some embodiments, the maximum weight that can be assigned to a link may be 1.0 and all other weights may be normalized with respect to the maximum weight. As shown, the links connecting the nodes 202-224 associated with a single transaction may have the maximum weight of 1.0. Conversely, nodes 202-224 having no relation or a relation below a threshold are not linked. For example, the Date₁ 202 may have no relation and/or a relation below a threshold to the Amount₂ 222 and, therefore, the Date₁ 202 may not be linked to the Amount₂ 222. Each node is also connected to other sufficiently similar nodes for other transactions. As stated above, the weight of link connecting the nodes of a similar type for different transactions is dependent on how closely those are nodes are connected. In some examples, as more transactions are input into the graph network 200, the weights between nodes may be updated based on the new transaction information.

In some embodiments, the threshold below which two nodes may not be linked may be input and/or the threshold may be determined using machine learning. For example, a machine-learning algorithm may be trained on a labelled data set where the labelled data set specifies different nodes that have some relationship to one another. Then, the trained machine-learning algorithm can be applied to a graph network to determine whether two nodes should be linked or not linked.

In some embodiments, the graph network 200 may be parsed into a plurality of groups based on a threshold weight. For example, a threshold weight of 0.3 may be set so that for links connecting nodes 202-224 that have a weight less than 0.3, the method 200 may parse or separate the nodes so that a plurality of groups are identified and each node within a specific group is linked with a sufficiently high weight to other nodes within the group. Additionally, as stated above, transaction statistics may be computed on the graph network 200 and/or groupings and may include density of nodes and/or links, size of nodes and/or links with the graph, and centrality of nodes and/or links with the graph.

FIG. 3 illustrates a flow diagram for a method 300 of quantifying spending behavior from a set of bank account transactions over a period of time. This diagram is merely an example, which should not unduly limit the scope of the claims. One of ordinary skill in the art would recognize many variations, alternatives, and modifications.

The method 300 may receive a plurality of financial transactions performed over a period of time and/or transaction statistics for the plurality of financial transactions from a database 305. The database 305 may be the same database 105 depicted in FIG. 1 or database 305 may be a database similar to database 105 depicted in FIG. 1 but updated to also include the output statistics associated with the transactions generated from method 100 in FIG. 1.

The method 300 provides benefits over conventional embodiments because it illustrates a trend and does not merely provide a static descriptor or snapshot of the payor's financials, such as the payor's available balance, whether the payor's bank account is in overdraft, and the number of monthly transactions. Rather, method 300 analyzes transactions over a period of time and performs statistical analysis on the transactions. The statistics that are generated are used as predictors and provide directional predictiveness of the payor's financial behavior and, therefore, can be used to assess the payor's ability to service or afford a credit product. For example, this method can illustrate whether the payor is paying his/her credit card, auto loan, mortgage, etc. along with the amount and velocity/frequency of those payments while also understanding the income and balance dynamics associated with the bank account. This is an improvement over receiving a static descriptor or snapshot of the payor's financials because this methodology generates dynamic statistics that have been trended to anticipate the direction of future credit scores. Current tools are merely descriptors and not predictors like the embodiments disclosed herein.

The method 300, which quantifies and predicts future spending behavior, may include a plurality of components. For example, the method may identify and examine (1) trends associated with bank transaction metrics, (2) trends associated with weekly spending patterns, (3) trends associated with weekly spending patterns in the presence of an abnormal (e.g., irregular) deposit or credit deposit and/or (4) the interaction between daily trends and weekly trends.

The method 300 may begin by aggregating the plurality of financial transactions performed over a period of time and/or transaction statistics (step 310). The method 300 may identify one or more similarities from the plurality of financial transactions and/or transaction statistics over a plurality of predetermined time intervals by calculating, e.g., a correlation coefficient between transactions (step 315).

The predetermined time intervals may be hours, weeks, months or years. In some examples, it may be preferable for the predetermined time intervals to be a week or a series of consecutive weeks. For each of the predetermined time intervals, the method 300 may create a plurality of spending metrics using the transaction statistics (step 320). For example, a first predetermined time interval of the plurality of predetermined time intervals may begin seven days prior to the current day and continue through to the current day; a second predetermined time interval may be the series of seven days that begin fourteen days prior to the current day; a third predetermined time interval may be the series of seven days that begin twenty-one days prior to the current day, etc. And, for each of these predetermined time intervals, the method 300 may create a set of spending metrics using the transactions statistics.

In some examples, the spending metrics may include aggregating and identifying timestamps across days over numerous cycles. This allows lenders to correlate the timing of the debits with credits for an entity. For example, if a credit transaction and a debit transaction occur within a threshold time of one another, the credit transaction and the debit transaction can be correlated. In some instances, the credit transaction and the debit transaction may have to occur within a threshold time of one another for a plurality of occurrences before the credit transaction and the debit transaction are associated with one another. In some aspects, the threshold time and/or the plurality of occurrences may be input by a user and/or determined using a machine-learning algorithm that is trained on a labelled data set that indicates when a credit transaction and a debit transaction are correlated.

In addition to correlating the timing of the debits with credits for an entity, lenders can identify where it is necessary to insert cash when debits minus credits is trending negative and/or proactively adjust debit timing or amount when debits minus credits are trending negative.

Step 320 may also include creating multiple subsets of account and/or spending metrics. For example, if there are 30 weekly account and/or spending metrics, it is possible to have numerous subsets created from those 30 weekly account and/or spending metrics.

Examples of account and/or spending metrics may include, but are not limited to, (i) the average running balance for different days of the week, (ii) the average inflows for different days of the week, (iii) the average outflow for different days of the weeks, (iv) the average repeat spending for different days of the week, (v) the average obligated spending for different days of the week, (vi) the average daily obligated spending for different days of the week, (vii) the average weekly obligated spending for different days of the week, (viii) the average biweekly obligated spending for different days of week, (ix) the average monthly obligated spending for different days of the week, (x) the count of obligated spending transactions for different days of the week, (xi) the count of daily obligated spending transactions for different days of the week, (xii) the count of weekly obligated spending transactions for different days of the week, (xiii) the count of biweekly obligated spending transactions for different days of the week, (xiv) the count of monthly obligated spending transactions for different days of the week, (xv) the count of weeks in overdraft for different days of the week, (xvi) the ratio of weeks in overdraft for different days of the week, (xvii) the worst amount owed in overdraft for different days of the week, (xviii) the average amount of available funds for a new payment for different days of the week, (xix) the day of week recommended for a new payment to minimize overdraft potential, (xx) the count of the repeat spending group, (xxi) the transaction description of the repeat spending group, (xxii) the count of total transactions of the repeat spending group, (xxiii) the average days between repeat spending of the repeat spending group, (xxiv) the average outflow amount of the repeat spending group, (xxv) the count of the repeat obligated spending group, (xxvi) the transaction description of the repeat obligated spending group, (xxvii) the periodicity of the repeat obligated spending group, (xxviii) the count of total transactions of the repeat obligated spending group, and/or (xxix) the average outflow amount of the repeat obligated spending group. In some examples, an obligatory transaction is a transaction that occurs on repetitive basis with similar periodicity, has a link to other transactions from the graph network that indicates similarity, and has a similar amount paid.

In some embodiments, the method 300 includes comparing each of the sets of spending metrics generated for the predetermined time periods (step 325). Based on the comparison, the method 300 may determine whether the spending metrics are increasing, decreasing or constant. The rate at which the spending metrics are increasing, decreasing, or constant may be referred to herein as the velocity of the spending metrics. If the spending metrics are changing, the method 300 may also determine whether the velocity of the spending metrics is accelerating.

Table 2 below illustrates an example of an entity's credits and debits during a period of weeks and Table 3 illustrates what time of day the entity receives the credits and funds are debited. As illustrated, the entity's credits (i.e., $5,255) on a bimonthly basis are constant. However, the entity's debits (i.e., $2,250, $2,750, $2,950, $3,150, $3,250, and $3,450) are trending upwards. And, the increases in the entity's debits from one pay period to the next are getting smaller. As such, while the entity's account balance is increasing, it's increasing by less each bi-monthly pay period. Stated another way, the change in velocity is decreasing. As such, a lender can make a more informed decision as to whether the entity can afford a particular credit product by analyzing these trends in the spending metrics. For example, a lender may determine that a user and/or entity can afford a particular credit product if the velocity and/or the change in velocity is above or below a threshold. In some examples, the velocity threshold and/or the change in velocity threshold may be input by a user and/or determined using a machine learning algorithm that is trained on a labeled data set where a good outcome (e.g., repayment of the credit product) or a bad outcome (e.g., the non-repayment of the credit product) is labelled and associated with a velocity and/or a change in velocity for the outcome.

A lender can also determine when it may be likely the debits become more than the credits at some time in the future. In some examples, a lender can also determine whether an insertion of cash is necessary to cover the debits due to the minimal time between the time stamps on debits and credits, as illustrated in Table 3.

In some examples, the method 300 may output the comparison and/or summary of comparison of the set(s) and/or subsets of metrics (step 330) over a period of time to illustrate a trend. In some embodiments, the method 300 may also include summarizing the spending metrics and/or the trends in the spending metrics. The method 300 may end or provide the output to another method, such as the methods depicted in FIGS. 4 and/or 5 of the present disclosure, for further analysis.

FIG. 4 illustrates a flow diagram of a method 400 for determining affordability from a set of bank account transactions over a period of time. This diagram is merely an example, which should not unduly limit the scope of the claims. One of ordinary skill in the art would recognize many variations, alternatives, and modifications.

The method 400 may provide benefits over conventional embodiments because it illustrates the payor's willingness and/or ability to afford payments for a given credit product. The method 400 may include identifying and analyzing a plurality of components. For example, the method 400 may identify and/or analyze (1) repetitive spending behavior, (2) repetitive financial obligations and (3) repetitive financial obligations that are currently owed and/or outstanding. After which, the method 400 may generate a set of attributes describing the periodicity of spending behavior for the same transactions utilizing results from the method 100 described above with respect to FIG. 1. The results are used to determine the time since, and the recency of, the same or similar spending, the amount of the spending, if that spending has ever caused an overdraft or insufficient funds, and the ratio of the proposed payment amount to existing payment amounts.

The method 400 may begin receiving a plurality of financial transactions performed over a period of time and/or transaction statistics for the plurality of financial transactions from a database 405. After receiving the transactions and/or statistics, the method 400 may aggregate the plurality of financial transactions performed over a period of time and/or transaction statistics for the plurality of financial transactions (step 410). The database 405 may be the same database 105 depicted in FIG. 1 or the database 305 depicted in FIG. 3.

In some embodiments, examples of transactions and/or statistics may include, but are not limited to, (i) the average running balance for different days of the week, (ii) the average inflows for different days of the week, (iii) the average outflow for different days of the weeks, (iv) the average repeat spending for different days of the week, (v) the average obligated spending for different days of the week, (vi) the average daily obligated spending for different days of the week, (vii) the average weekly obligated spending for different days of the week, (viii) the average biweekly obligated spending for different days of week, (ix) the average monthly obligated spending for different days of the week, (x) the count of obligated spending transactions for different days of the week, (xi) the count of daily obligated spending transactions for different days of the week, (xii) the count of weekly obligated spending transactions for different days of the week, (xiii) the count of biweekly obligated spending transactions for different days of the week, (xiv) the count of monthly obligated spending transactions for different days of the week, (xv) the count of weeks in overdraft for different days of the week, (xvi) the ratio of weeks in overdraft for different days of the week, (xvii) the worst amount owed in overdraft for different days of the week, (xviii) the average amount of available funds for a new payment for different days of the week, (xix) the day of week recommended for a new payment to minimize overdraft potential, (xx) the count of the repeat spending group, (xxi) the transaction description of the repeat spending group, (xxii) the count of total transactions of the repeat spending group, (xxiii) the average days between repeat spending of the repeat spending group, (xxiv) the average outflow amount of the repeat spending group, (xxv) the count of the repeat obligated spending group, (xxvi) the transaction description of the repeat obligated spending group, (xxvii) the periodicity of the repeat obligated spending group, (xxviii) the count of total transactions of the repeat obligated spending group, and/or (xxix) the average outflow amount of the repeat obligated spending group. In some examples, an obligatory bank transaction is a transaction that occurs on repetitive basis with similar periodicity, has a link to other transactions from the graph network that indicates similarity, and has a similar amount paid.

In some embodiments, the method 400 may include identifying repetitive financial transactions and/or repetitive bank transaction statistics from the plurality of financial transactions and/or the transaction statistics for the plurality of financial transactions over a predetermined period of time (step 415). The predetermined period or interval of time may include one or more hours, one or more days, one or more weeks, one or more months or one or more years. For example, it may be preferable to identify one or a set of repetitive financial transactions and/or one or a set of repetitive bank transaction statistics from the plurality of financial transactions for a certain number (e.g., 2, 3, 4, . . . , 52, . . . etc.) of weeks or a certain number (e.g., 2, 3, 4, 5, 6, 7, 8, 9, 10, 11, 12, . . ., 24, . . . 36, . . . etc.) of months. A repetitive bank transaction is a bank transaction that is the same or substantially similar to one or more other financial transactions that occur at a substantially regular interval and therefore repeats over the predetermined period of time and may be determined by the graph network linkage. For example, a repetitive bank transaction is a transaction that occurs at a substantially regular interval, such as most or every 4 weeks or every last week of every month and/or involves the payor paying the same payee. The amount for the repetitive bank transaction may be the same, similar or different. Similarly, repetitive bank transaction statistics are the statistics for the plurality of financial transactions over a predetermined period of time are statistics that are the same or substantially similar to one or more other statistics that occur at a substantially regular interval and therefore repeats over the predetermined period of time.

The method 400 may also include identifying one or more obligatory financial transactions from the repetitive financial transactions and/or repetitive bank transaction statistics over a predetermined interval of time (step 420). In some embodiments, an obligatory transaction may be identified based on the data associated with a transaction (e.g., the description of the transaction (e.g., the clean description), amount, payee, metadata associated with the transaction, whether a late fee is accessed in the absence of an on-time payment, etc.), a machine-learning algorithm that is trained on a labelled data set that labels mandatory transactions and the data associated with the transactions, and/or the like

The method 400 may also include identifying whether the one or more obligatory financial transactions are being satisfied or remain unsatisfied (step 425). To determine if an obligatory financial transaction is satisfied, the method 400 may include determining whether the obligatory financial transaction is absent during a time period for which the obligatory financial transaction should have been paid. If the obligatory financial transaction is absent during a time period for which the obligatory financial transaction should have been paid, then the method 400 may determine the obligatory financial transaction is not being satisfied. Additionally, or alternatively, If the obligatory financial transaction causes an overdraft of an account, then the method 400 may determine the obligatory financial transaction is not being satisfied. Conversely, if the obligatory financial transaction is present during every time period for which the obligatory financial transaction should have been paid and the obligatory financial transaction does not result in an overdraft, then the method 400 may determine the obligatory financial transaction is being satisfied. The bank statistics and whether obligatory financial transaction are being satisfied or not satisfied may be referred to herein as spending attributes of an entity.

In some embodiments, the method 400 may also include generating an affordability index for an entity (step 430). To do so, the method 400 may include normalizing the attributes for a plurality of entities (e.g., consumers or businesses). Based on the normalization, each entity may be assigned an affordability index on a scale of 0 to 1. A higher index vale indicates an entity is able to afford more credit products than entities with a lower index value. In some embodiments, the method 400 may include determining a trend of the affordability index for each of the entities. The trend indicates whether the affordability of the entity is increasing or decreasing.

In some embodiments, the affordability index may include one or more of the following: (i) an indicator of experience with a similar payment amount as the offer/requested payment amount, (ii) an indicator of ever overdrafting a similar payment amount as the offer/requested payment amount, (iii) days since overdrafting a similar payment amount as the offer/requested payment amount, (iv) recommended day of week to minimize overdrafts for the offer/requested payment amount, (v) recommended payment amount to minimize overdrafts instead of the offer/requested payment amount, and/or (vi) recommended payment terms to minimize overdrafts for the offer/requested payment amount.

In some embodiments, the method 400 includes generating an affordability score and/or recommendation (step 435). The score and/or recommendation may be generated using machine learning based on the affordability index that is determined for each entity. For example, a machine learning algorithm may be trained on a labelled data set where the affordability scores, recommendations, and/or different credit products (e.g., different amounts, terms, and rates) are used as the inputs and the outputs are whether those credit products are current, delinquent, in default, etc. Then, when an index of affordability and/or recommendation is determined for a new entity, the index of affordability and a specific credit product can be input into the machine learning algorithm and the algorithm can output a score and/or recommendation indicating the ability for the new entity to afford a specific credit product. In some examples, the score may be on a scale of 100 to 300 where a score of 300 indicates the highest ability to afford the specific credit product.

Additionally, or alternatively, the method 400 (block 435) may output whether it is recommended to provide the new entity with the specific credit product. In some embodiments, the recommendation may output that an entity cannot afford a credit product. Alternatively, the recommendation may output that an entity can afford a credit product. Additionally, or alternatively, the recommendation for the credit product may include the recommended terms (e.g., interest rate, duration, etc.), the recommended payment amount, and/or the recommended day of the week and/or month for payments to be made. Because of the analysis performed by methods 100, 300, 400, recommended terms, payment amounts, days of the week/month for payments to be made can be provided, which can lead to an increase in the number of approvals for entity's over conventional embodiments. As such, more entity's can secure financing than otherwise could leading to an improvement over conventional embodiments.

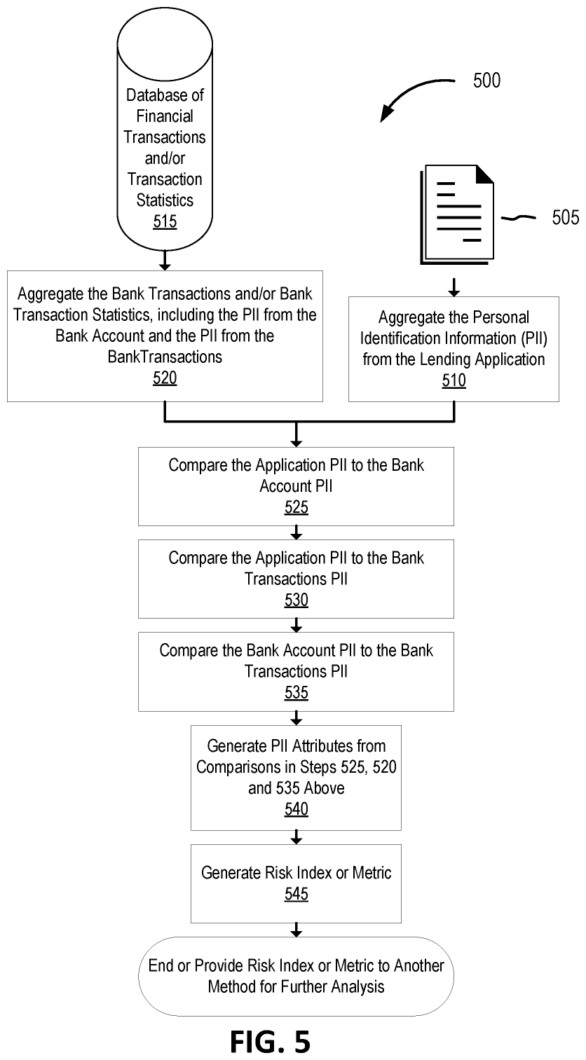

Referring to FIG. 5 there is depicted an illustration of a flow diagram for a method 500 of identifying fraud risk from a set of bank account transactions over a period of time. This diagram is merely an example, which should not unduly limit the scope of the claims. One of ordinary skill in the art would recognize many variations, alternatives, and modifications.

The method 500 may begin by receiving a first set of personal identification information (PII) associated with a lending application or purchasing transaction (405) and aggregating the PII from the lending application or purchasing transaction (step 510). The method 500 may receive a second set of personal identification information associated with a bank account from a database 515, wherein the plurality of financial transactions comprises one or more corresponding sets of personal identification information (step 520). The database 515 may be the same database 105 depicted in FIG. 1, the database 305 depicted in FIG. 3, and/or the database 405 depicted in FIG. 4.

The method 500 may include comparing the first set of PII associated with the lending application and/or purchasing transaction with a second set of PII associated with the bank account (step 525). The method 500 may include comparing the first set of PII associated with the lending application and/or purchasing transaction with one or more corresponding sets of PII associated with the plurality of financial transactions (step 530). The method 500 may include comparing the second set of PII associated with the bank account with one or more corresponding sets of PII associated with the plurality of financial transactions (step 535).

For each of the comparisons, the method 500 may include generating PII attributes (step 540). The PII attributes may be time-based measurements, amounts, minimum, maximum, means and medians of the comparisons made in steps 525, 530 and 535. The attributes may also be trends, ratio of trends, and/or ratios of: the time-based measurements, amounts, minimum, maximum, means and medians of the comparisons made in steps 525, 530 and 535. In some embodiments, a machine learning algorithm may be trained using the PII attributes such that the labelled data set used to train the machine-learning algorithm includes the PII attributes as inputs and the outputs are whether the PII attributes correspond to lending application 505 fraud. Then, when new PII attributes are determined for a new lending application 505, the PII attributes corresponding to the new lending application 505 can be input into the machine-learning algorithm and the algorithm can output a risk index (e.g., on a scale of 1-10) indicating a likelihood of whether the new lending application 505 corresponds to a fraudulent lending application (step 545).

Once the attributes from step 540 and/or the risk index is generated in step 545 in method 500, those attributes and/or risk index may be used by other methods described in this disclosure, such as the method for quantifying spending behavior from financial transactions depicted in FIG. 3 and/or the method for determining affordability from financial transactions depicted in FIG. 4 and/or the method 100 of identifying and/or determining relationships between a set of bank account transactions over a period of time in FIG. 5. In fact, any of the four methods described herein may be used alone or in any combination.

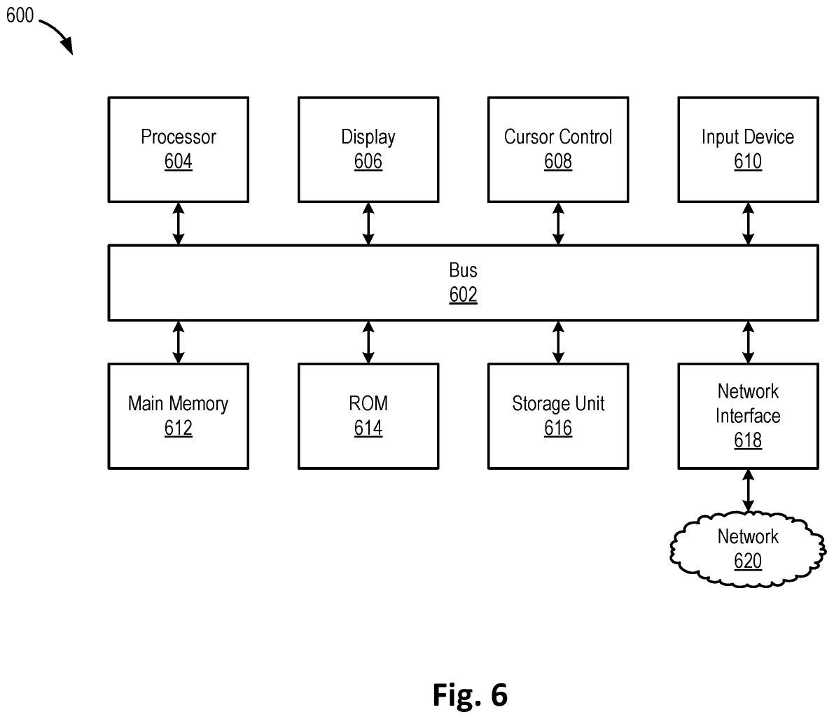

FIG. 6 is an illustration of a block diagram of an example computer system which may be used to implement all or certain or a combination of the methods illustrated in FIGS. 1, 3-5 and/or implement all or certain or a combination aspects of the examples discussed herein. In aspects, some or all of the methods 100, 300, 400, and/or 500 may be performed using the computer system 600. This diagram is merely an example, which should not unduly limit the scope of the claims. One of ordinary skill in the art would recognize many variations, alternatives, and modifications.

The computing system 600 includes a bus 602 or other communication mechanism for communicating information between, a processor 604, a display 606, a cursor control component 608, an input device 610, a main memory 612, a read only memory (ROM) 614, a storage unit 616, and/or a network interface 618. In some examples, the bus 602 is coupled to the processor 604, the display 606, the cursor control component 608, the input device 610, the main memory 612, the ROM 614, the storage unit 616, and/or the network interface 618. And, in certain examples, the network interface 618 is coupled to a network 620.

In some examples, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For example, the instructions, when stored in the storage unit 616 accessible to processor 604, render the computing system 600 into a special-purpose machine that is customized to perform the operations specified in the instructions (e.g., the instructions stored in the components 300). In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control 608 (e.g., a mouse, a trackball, or cursor direction keys) is configured to communicate additional information and commands (e.g., to control cursor movements on the display 606) to the processor 604.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all the described features. Accordingly, the scope of the present disclosure is intended to embrace all such alternatives, modifications, and variations as fall within the scope of the claims, together with all equivalents thereof.

What is claimed is:

1. A system for determining an affordability index, the system comprising:
at least one processor; and
memory storing instructions that, when executed by the at least one processor, causes the system to perform a set of operations, the set of operations comprising:
receiving a plurality of financial transactions for an entity during a period of time, wherein each of the plurality of financial transactions comprises one or more descriptions;
cleaning the descriptions from the plurality of financial transactions to create one or more corresponding clean descriptions;
populating a plurality of fields with field entries using the clean descriptions; and
producing a graph network comprising a plurality of nodes and links, wherein the nodes correspond to the field entries and the links connect one or more of the field entries based on a similarity of the field entries.

2. The system of claim 1, the set of operations further comprising determining a similarity between field entries.

3. The system of claim 1, wherein the links comprise weights corresponding to a similarity between the field entries.

4. The system of claim 1, the set of operations further comprising:
creating a first set of metrics for similarities over a first of the predetermined interval of time;
creating a second set of metrics for similarities over a second of the predetermined interval of time, wherein the second of the predetermined interval of time is a same duration as the first of the predetermined interval of time but a different in range than first of the predetermined interval of time;
comparing the first set of metrics to the second set of metrics; and
outputting the comparison and/or summary of comparison of the first set and second set of metrics.

5. The system of claim 4, wherein the predetermined interval of time comprises at least one of hours, days, weeks, months and years.

6. The system of claim 4, the set of operations further comprising:
determining a trend for the first set of metrics; and
determining a velocity of the trend.

7. The system of claim 6, the set of operations further comprising determining a change of the velocity of the trend.

8. The system of claim 1, the set of operations further comprising:
identifying repetitive financial transactions from the plurality of financial transactions during a predetermined interval of time;
identifying one or more obligatory financial transactions from the repetitive financial transactions;
identifying whether the one or more obligatory financial transactions are being satisfied; and
generating an affordability index for a type of transaction similar to the one or more obligatory financial transactions based upon whether the obligatory financial transactions are being satisfied.

9. The system of claim 8, wherein the predetermined interval of time comprises at least one of hours, days, weeks, months and years.

10. The system of claim 8, the set of operations further comprising determining a trend associated with the satisfaction of the obligatory financial transactions.

11. The system of claim 8, the set of operations further comprising determining a risk index based on the affordability index.

12. The system of claim 8, the set of operations further comprising generating an affordability recommendation for the type of transaction based on the affordability index.

13. The system of claim 12, wherein the affordability recommendation corresponds to whether the entity can afford a credit product associated with the type of transaction

14. The system of claim 13, wherein, in response to determining the entity can afford a credit product, the set of operations further comprises providing recommended terms, a payment amount, and a day of the week for the payment amount to be paid.

15. The system of claim 1, the set of operations further comprising:
receiving a first set of personal identification information associated with a lending application;
receiving a second set of personal identification information associated with a bank account;
comparing the first set of personal identification information associated with the lending application with the plurality of financial transactions;
comparing the second set of personal identification information associated with the bank account with the plurality of financial transactions; and
generating a risk index based upon the comparisons, wherein the risk index corresponds to whether the first set of personal identification and the second set of personal identification information are associated with the entity.

16. A method for determining an affordability index, the method comprising:
receiving a plurality of financial transactions for an entity during a period of time, wherein each of the plurality of financial transactions comprises one or more descriptions;
cleaning the descriptions from the plurality of financial transactions to create one or more corresponding clean descriptions;
populating a plurality of fields with field entries using the clean descriptions; and
producing a graph network comprising a plurality of nodes and links, wherein the nodes correspond to the field entries and the links connect one or more of the field entries based on a similarity of the field entries.

17. The method of claim 16, further determining a similarity between field entries.

18. The method of claim 16, further comprising:
creating a first set of metrics for similarities over a first of the predetermined interval of time;
creating a second set of metrics for similarities over a second of the predetermined interval of time, wherein the second of the predetermined interval of time is a same duration as the first of the predetermined interval of time but a different in range than first of the predetermined interval of time;
comparing the first set of metrics to the second set of metrics; and
outputting the comparison and/or summary of comparison of the first set and second set of metrics.

19. The method of claim 16, further comprising:
identifying repetitive financial transactions from the plurality of financial transactions during a predetermined interval of time;
identifying one or more obligatory financial transactions from the repetitive financial transactions;
identifying whether the one or more obligatory financial transactions are being satisfied; and
generating an affordability index for a type of transaction similar to the one or more obligatory financial transactions based upon whether the obligatory financial transactions are being satisfied.

20. The method of claim 16, further comprising:
receiving a first set of personal identification information associated with a lending application;
receiving a second set of personal identification information associated with a bank account;
comparing the first set of personal identification information associated with the lending application with the plurality of financial transactions;
comparing the second set of personal identification information associated with the bank account with the plurality of financial transactions; and
generating a risk index based upon the comparisons, wherein the risk index corresponds to whether the first set of personal identification and the second set of personal identification information are associated with the entity.
